(19) United States
(12) Patent Application Publication
(10) Pub. No.: US 2007/0080264 A1
(43) Pub. Date: Apr. 12, 2007

(54) Articulating lift gate speakers

(76) Inventors: Richard Kukucka, Ann Arbor, MI (US); Brian Chaloult, Rochester Hills, MI (US); Erin Soisson, Detroit, MI (US)

Correspondence Address: DAIMLERCHRYSLER INTELLECTUAL CAPITAL CORPORATION;CIMS 483-02-19, 800 CHRYSLER DR EAST, AUBURN HILLS, MI, 48326-2757, US

(21) Appl. No.: 11/237,352

(22) Filed: Sep. 28, 2005

(51) Int. Cl. G12B 9/00

(52) U.S. Cl. 248/27.1

(57) ABSTRACT

A stereo system for a vehicle includes at least one speaker rotatably mounted to an access door of the vehicle between a stowed position and a deployed position. The at least one speaker directs sound to an area within the vehicle in the stowed position and directs sound to an area outside of the vehicle in the deployed position.

### FIELD OF THE INVENTION

The present invention relates to stereo systems and, more particularly, to an improved stereo system for a vehicle.

### BACKGROUND OF THE INVENTION

Minivans and sport utility vehicles are often used prior to sporting events and concerts as platforms for “tailgating.” Tailgating typically involves opening a rear access door of a vehicle to provide a platform for food and beverage, seating, and storage (i.e., lawn chairs, cooking utensils, sporting equipment, etc.). In essence, the rear of the vehicle becomes the focal point of the tailgate party by providing users with an all-in-one kitchen, entertainment center, and garage. Because the rear of the vehicle is typically where most people congregate during a tailgate party, a stereo system of the vehicle is often used to provide music and/or broadcasts of a sporting event or concert.

Conventional vehicle stereo systems are designed to deliver sound to occupants of the vehicle. As such, most speakers associated with conventional vehicle stereo systems are directed toward seating locations within the vehicle and provide adequate sound to passengers seated in the vehicle. However, when the same speakers are used for events where the intended listening audience is outside of the vehicle, such as a tailgate party, conventional vehicle stereo systems fail to deliver adequate sound.

### SUMMARY OF THE INVENTION

A stereo system for a vehicle includes at least one speaker rotatably mounted to an access door of the vehicle between a stowed position and a deployed position. The at least one speaker directs sound to an area within the vehicle in the stowed position and directs sound to an area outside of the vehicle in the deployed position.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a perspective view of a vehicle access door incorporating a stereo system in accordance with the principles of the present invention; and

FIG. 2 is a perspective view of the access door of FIG. 1 in an open position with the stereo system of FIG. 1 in a deployed position.

### DETAILED DESCRIPTION OF THE PREFERRED EMBODIMENTS

The following description of the preferred embodiment(s) is merely exemplary in nature and is in no way intended to limit the invention, its application, or uses.

With reference to the figures, a stereo system 10 for use with a vehicle 12 is provided. The stereo system 10 includes a pair of speakers 14 that are rotatable between a stowed position and a deployed position. In the stowed position, the speakers 14 direct sound to an interior compartment 16 of the vehicle 12. In the deployed position, the speakers 14 direct sound to an area. generally outside of the interior compartment 16 and away from the vehicle 12. It should be understood that while the present invention will be described hereinafter and in the drawings as including a pair of speakers that the stereo system 10 of the present invention may include fewer or more speakers.

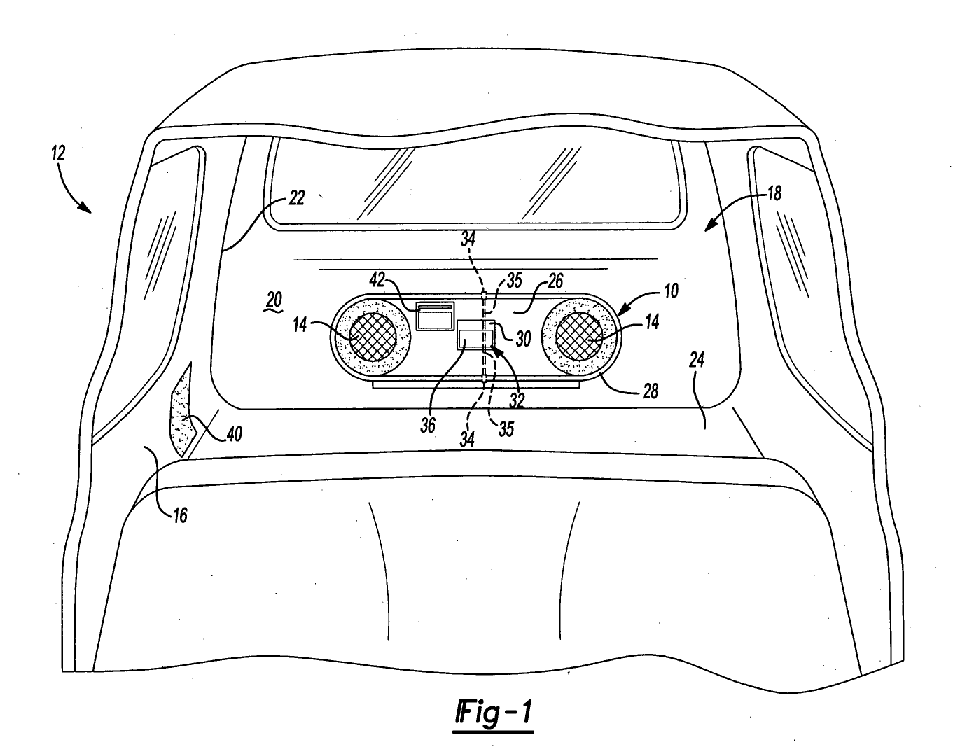

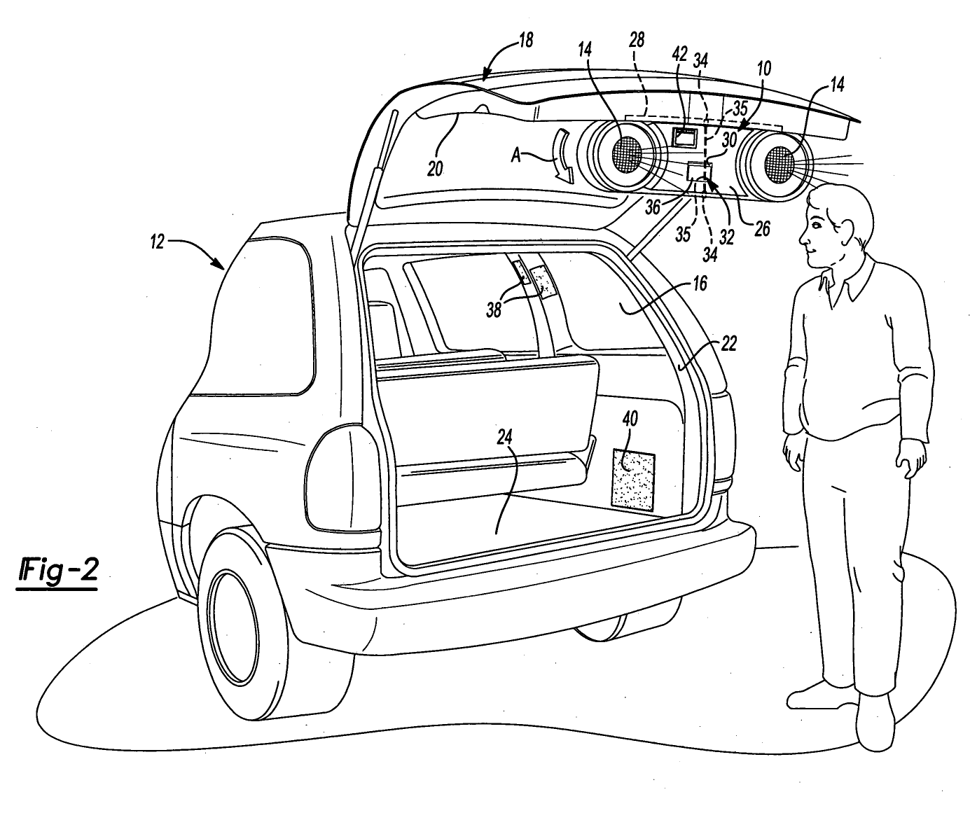

With particular reference to FIGS. 1 and 2, the vehicle 12 is shown to include an access door 18 such as a rear lift gate or hatchback having an interior surface 20 generally facing the interior compartment 16. The access door 18 is rotatable relative to a vehicle body opening 22 between an open position (FIG. 2) and a closed position (FIG. 1). In the closed position, the interior surface 20 of the access door 18 faces the interior compartment 16 and effectively prevents entry into the vehicle 12 through the body opening 22. In the open position, the interior surface 20 is generally perpendicular to the body opening 22 such that the interior surface 20 is parallel with a load floor 24 of the vehicle 12 and access to the interior compartment 16 is permitted.

The speakers 14 are attached to a housing 26 having a pivot 28 and a locking region 30. The pivot 28 is attached to the interior surface 20 of the access door 18 and allows the speakers 14 to be rotated between the stowed position and the deployed position. The locking region 30 is disposed generally opposite the pivot 28 and receives a locking mechanism 32.

The locking mechanism 32 selectively locks the housing 26 in one of the stowed position or the deployed position and includes a pair of latches 34 and an actuation handle 36. In operation, a force is applied generally to the actuation handle 36 to rotate the actuation handle 36 relative to the housing 26. Sufficient rotation of the actuation handle 36 relative to the housing 26 applies a tensile force to a pair of cables 35 disposed generally between the actuation handle 36 and the latches 34 causing each latch 34 to release and disengage the access door 18. Once the latches 34 are released, rotation of the housing 26, and thus the speakers 14, relative to the access door 18 is permitted. Once the housing 26 is sufficiently rotated relative to the access door 18, the locking mechanism 32 re-engages the access door 18 to hold the housing 26 in the deployed position. To return the housing 26 to the stowed position, a force is once again applied to the actuation handle 36 to disengage the locking mechanism 32 from the access door 18.

It should be noted that while a pair of latches 34 is disclosed that the locking mechanism 32 may include more or fewer latches 34 that selectively prevent rotation of the housing 26 relative to the access door 18. Furthermore, it should be noted that while the locking mechanism 32 is described as capable of locking the housing 26 in either the stowed position or the deployed position, that the locking mechanism 32 may be configured such that the housing 26 is only locked relative to the access door 18 in the stowed position. As such, when the housing 26 is in the deployed position, the housing 26 may be free to rotate relative to the access door 18.

With particular reference to FIG. 2, operation of the stereo system 10 will be described in detail. When the access door 18 is in the closed position, the speakers 14 are positioned in the stowed position such that sound from the speakers 14 is directed toward the interior compartment 16 of the vehicle 12 in a direction generally perpendicular to the body opening 22.

When the vehicle 12 is at rest and the access door 18 is in the open position, the housing 26, and thus the speakers 14, may be rotated relative to the access door 18 to provide sound to an area generally outside of the interior compartment 16.

Once the access door 18 is in the open position, a force may be applied to the actuation handle 36 to rotate the actuation handle 36 relative to the access door 18. Sufficient rotation of the actuation handle 36 causes the latches 34 to release engagement with the access door 18. Once the latches 34 are released, the housing 26 may be rotated relative to the access door 18 from the stowed position to the deployed position. Rotational movement of the housing 26 relative to the access door 18 is represented by arrow “A” in FIG. 2.

Once sufficiently rotated into the deployed position, the locking mechanism 32 may once again lock the housing 26 relative to the access door 18 to prevent further rotation of the housing 26 relative to the access door 18. However, as previously discussed, the locking mechanism 32 may only prevent rotation of the housing 26 when in the stowed position. Therefore, depending on the configuration of the locking mechanism 32, the housing 26 may or not be locked relative to the access door 18 when in the deployed position.

Once the housing 26 is sufficiently rotated into the deployed position, the speakers 14 are positioned such that sound from each speaker 14 is directed away from the vehicle 12 and in a direction generally perpendicular to the vehicle body opening 22. Such sound direction is generally opposite to a direction of sound when the speakers 14 are in the stowed position.

To return the housing 26 to the stowed position, a force is applied to the actuation handle 36 to release the locking mechanism 32 and allow rotation of the housing 26 relative to the access door 18. If the locking mechanism 32 does not lock the housing 26 in the deployed position, a rotational force is simply applied to the housing 26 to rotate the housing 26 relative to the access door 18. In either configuration, the housing 26 is rotated relative to the access door 18 until the locking mechanism 32 engages the housing 26 and locks the housing 26 in the stowed position. Once in the stowed position, the access door 18 may be rotated from the open position to the closed position. When the access door 18 is returned to the closed position, sound from the speakers 14 is once again directed toward the interior compartment 16 of the vehicle 12 in a direction substantially opposite from the direction of sound when the speakers 14 are in the deployed position.

The stereo system 10 of the present invention may include other speakers and components to enhance sound quality. For example, the stereo system 10 may optionally include other speakers 38 positioned at various locations within the interior compartment 16 that direct sound both away from the body opening 22 (i.e., toward the interior compartment 16) and toward the body opening 22. One such speaker is a subwoofer 40. The subwoofer 40 is preferably disposed near the body opening 22 so that sound from the speakers 14 is enhanced when the speakers 14 are in stowed position and when the speakers 14 are in the deployed position.

In addition to being rotatably mounted to the access door, the stereo system 10 of the present invention may optionally be detachable from the access door 18. A detachable housing 26 may include a transmitter for receiving and transmitting radio signals, a tape player, a compact disc player, an MP3 player, and a power source (all schematically represented by reference number 42). When detached from the vehicle 12, the power source 42 supplies power to the various components to provide a portable stereo.

As described, the stereo system 10 of the present invention includes a pair of speakers 14 that deliver sound to occupants of a vehicle 12 when in the stowed position and also to people outside of the vehicle 12 in a deployed position. Therefore, the stereo system 10 of the present invention is ideal for a vehicle whose sound system will be used both during driving conditions and during periods of recreation.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A stereo system for a vehicle comprising:
at least one speaker rotatably mounted to an access door of the vehicle between a stowed position and a deployed position, said at least one speaker directing sound to an area within the vehicle in said stowed position and directing sound to an area outside of the vehicle in said deployed position.

2. The stereo system of claim 1, further comprising a locking mechanism operable to selectively hold said at least one speaker in said stowed position.

3. The stereo system of claim 1, wherein said at least one speaker is rotated ninety degrees from said stowed position to achieve said deployed position.

4. The stereo system of claim 1, wherein said at least one speaker is removable from said access door.

5. The stereo system of claim 4, wherein said at least one speaker includes a power source movable therewith to power said at least one speaker when said at least one speaker is removed from said access door.

6. The stereo system of claim 1, wherein said access door of the vehicle is a rear access door.

7. An access door for a vehicle comprising:
an interior surface facing an internal compartment of the vehicle when the access door is in a closed position; and
at least one speaker rotatably mounted to said interior surface and rotatable between a stowed position and a deployed position, said at least one speaker facing said internal compartment when the access door is in said closed position and facing away from said internal compartment when said access door is in an open position and said at least one speaker is in said deployed position.

8. The access door of claim 7, further comprising a locking mechanism operable to selectively lock said at least one speaker in said stowed position.

9. The access door of claim 8, wherein said locking mechanism is operable to selectively lock said at least one speaker in said deployed position.

10. The access door of claim 7, wherein said at least one speaker is rotated ninety degrees from said stowed position to achieve said deployed position.

11. The access door of claim 7, wherein said at least one speaker is removable from the access door.

12. The access door of claim 11, wherein said at least one speaker includes a power source movable therewith to power said at least one speaker when said at least one speaker is removed from the access door.

13. A vehicle comprising:
a body opening;
an access door operable between a closed position preventing access to the vehicle and an open position allowing access to the vehicle;
at least one speaker rotatably mounted to said access door between a stowed position and a deployed position, said at least one speaker facing an interior compartment of the vehicle when said access door is in said closed position and said at least one speaker is in said stowed position and facing away from said interior compartment when said access door is in said open position and said at least one speaker is in said deployed position.

14. The vehicle of claim 13, further comprising a locking mechanism operable to selectively lock said at least one speaker in said stowed position.

15. The access door of claim 14, wherein said locking mechanism is operable to selectively lock said at least one speaker in said deployed position.

16. The access door of claim 13, wherein said at least one speaker is rotated ninety degrees from said stowed position to achieve said deployed position.

17. The access door of claim 13, wherein said at least one speaker is removable from said access door.

18. The access door of claim 13, wherein said at least one speaker includes a power source movable therewith to power said at least one speaker when said at least one speaker is removed from said access door.
